(19) United States
(12) Patent Application Publication
(10) Pub. No.: US 2022/0164760 A1
(43) Pub. Date: May 26, 2022

(54) UNMANNED GOODS SUPPLY SYSTEM USING A DRONE

(71) Applicant: ELECTRONICS AND TELECOMMUNICATIONS RESEARCH INSTITUTE, Daejeon (KR)

(72) Inventors: Yong Hoon CHOI, Daejeon (KR); Sung Hee KIM, Daejeon (KR); Hoon JUNG, Daejeon (KR)

(73) Assignee: ELECTRONICS AND TELECOMMUNICATIONS RESEARCH INSTITUTE, Daejeon (KR)

(21) Appl. No.: 17/477,919

(22) Filed: Sep. 17, 2021

(30) Foreign Application Priority Data
Nov. 20, 2020 (KR) 10-2020-0156999

(51) Int. Cl. G06Q 10/08; B64C 39/02; B64F 1/32

(52) U.S. Cl. CPC G06Q 10/083; B64C 39/024; B64C 2201/146; B64C 2201/027; B64C 2201/128; B64F 1/32

(57) ABSTRACT

Disclosed is an unmanned goods supply system using a drone. The unmanned goods supply system includes a landing unit to which delivery goods are mailed by a drone; a transfer unit for transferring the delivery goods mailed to the landing unit; a loading unit that is located under the landing unit and stores the delivery goods transported by the transfer unit; and an interface unit for delivering the delivery goods stored in the loading unit to a customer. The transfer unit includes a first transfer unit that is installed on the landing unit and horizontally transports the delivery goods to a predetermined region on the landing unit, and a second transfer unit for transferring the delivery goods collected in the predetermined region to the loading unit.

### CROSS-REFERENCE TO RELATED APPLICATION

This application claims priority to and the benefit of Korean Patent Application No. 10-2020-0156999 filed in the Korean Intellectual Property Office on Nov. 20, 2020, the entire contents of which are incorporated herein by reference.

### BACKGROUND OF THE INVENTION

### (a) Field of the Invention

The present invention relates to an unmanned goods supply system using a drone, and more particularly, to an unmanned goods supply system using a drone for delivering goods.

### (b) Description of the Related Art

Delivery technology using drones is advancing. In particular, research on delivering goods to customers in vulnerable regions for delivering, such as regions with extremely low population density and underdeveloped regions, by using drones is continuing.

However, a separate transportation means or a separate storage space is required in order to finally deliver the goods dropped or landed from the air by the drone to the customer.

The above information disclosed in this Background section is only for enhancement of understanding of the background of the invention, and therefore it may contain information that does not form the prior art that is already known in this country to a person of ordinary skill in the art.

### SUMMARY OF THE INVENTION

The present invention has been made in an effort to provide an unmanned goods supply system having advantages of allowing customers in vulnerable regions to conveniently pick up goods delivered at a desired time.

An exemplary embodiment of the present invention provides an unmanned goods supply system using a drone. The unmanned goods supply system includes: a landing unit to which delivery goods are mailed by the drone; a transfer unit for transferring the delivery goods mailed to the landing unit; a loading unit that is located under the landing unit and stores the delivery goods transported by the transfer unit; and an interface unit for delivering the delivery goods stored in the loading unit to a customer, wherein the transfer unit includes a first transfer unit that is installed on the landing unit and horizontally transports the delivery goods to a predetermined region on the landing unit, and a second transfer unit for transferring the delivery goods collected in the predetermined region to the loading unit.

In a possible implementation, the second transfer unit may include a stacker crane that transfers the delivery goods up, down, left, and right, and puts the delivery goods into the loading unit.

In a possible implementation, the second transfer unit may further include a navigation unit for finding an empty loading unit to which the delivery goods are put.

In a possible implementation, the transfer unit may further include a plurality of sensors for recognizing the delivery goods, and a monitoring control unit for monitoring the delivery goods.

In a possible implementation, the landing unit may include: a support unit on which the delivery goods are mounted; and an opening/closing unit that is installed on the support unit and opens and closes the support unit.

In a possible implementation, the landing unit may further include a landing control unit for controlling a position at which the delivery goods are landed.

In a possible implementation, the loading unit may include: a plurality of container boxes for storing the delivery goods; and a goods loading means for putting the delivery goods located in front of the container box by the second transfer unit into the container box.

In a possible implementation, the unmanned goods supply system may further include: a control unit for controlling the landing unit, the loading unit, the transfer unit, and the interface unit; and a remote operation unit connected to the drone and the control unit to control the control unit through communication.

In a possible implementation, the remote operation unit may be connected to the drone and the control unit in a predetermined communication method to detect that the drone takes off from the landing unit and delivers it to the control unit.

In a possible implementation, the control unit and the remote operation unit may notify the customer through a predetermined communication means.

### BRIEF DESCRIPTION OF THE DRAWINGS

FIG. 1 is a schematic diagram of an unmanned goods supply system using a drone according to an embodiment of the present invention.

FIG. 2 is a partial cross-sectional view of an unmanned goods supply system using a drone according to an embodiment of the present invention.

FIG. 3 is a plan view of a first transfer unit of an unmanned goods supply system using a drone according to an embodiment of the present invention.

### DETAILED DESCRIPTION OF THE EMBODIMENTS

Hereinafter, with reference to the accompanying drawings, various embodiments of the present invention will be described in detail so that those of ordinary skill in the art can easily carry out the present invention. The present invention may be embodied in many different forms and is not limited to the embodiments described herein.

In order to clearly explain the present invention, units that are irrelevant to the description are omitted, and the same reference numerals are assigned to the same or similar elements throughout the specification.

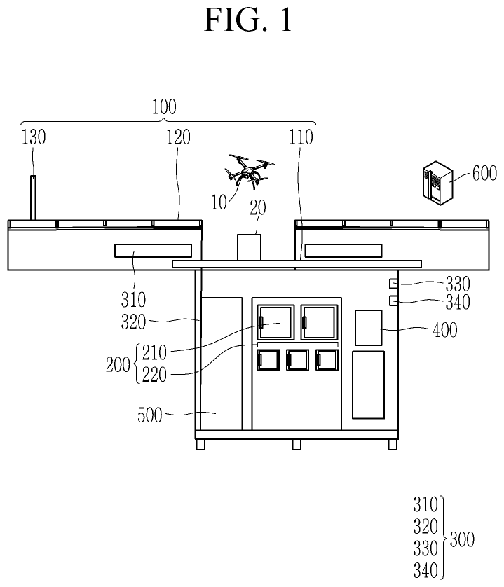

Now, an unmanned goods supply system using a drone according to an embodiment of the present invention will be described in detail with reference to FIGS. 1 to 3.

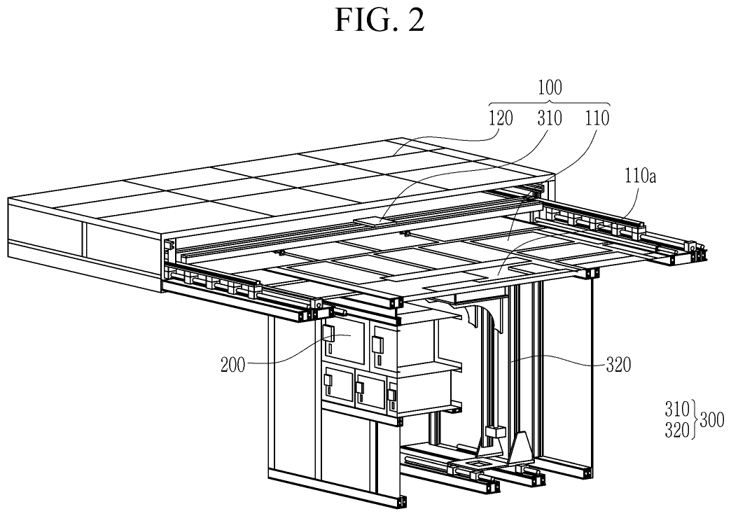

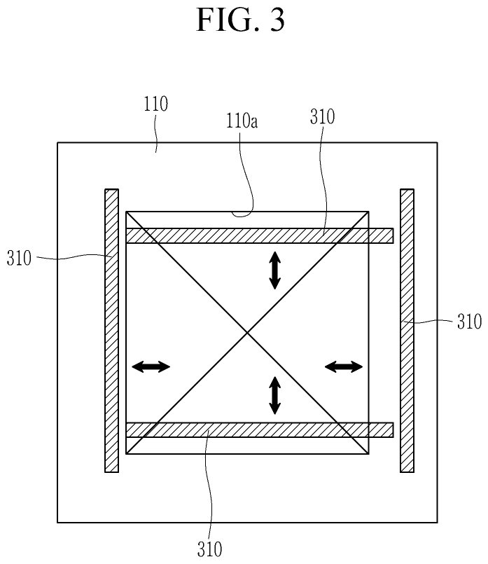

FIG. 1 is a schematic diagram of an unmanned goods supply system using a drone according to an embodiment of the present invention, FIG. 2 is a perspective view of an unmanned goods supply system using a drone according to an embodiment of the present invention, and FIG. 3 is a plan view of a first transfer unit of an unmanned goods supply system using a drone according to an embodiment of the present invention.

As shown in FIG. 1 to FIG. 3, the unmanned goods supply system using a drone according to an embodiment of the present invention includes a landing unit 100, a transfer unit 300, a loading unit 200, an interface unit 400, a control unit 500, and a remote operation unit 600.

A drone 10 is landed in the landing unit 100 or delivery goods 20 delivered by the drone 10 may be put in the landing unit 100. The delivery goods 20 may be a medium or large article of 10 kg or more.

The landing unit 100 may include a support unit 110, an opening/closing unit 120, and a landing control unit 130.

The support unit 110 is a landing site on which the delivery goods 20 is mounted, and is located above the loading unit 200, the interface unit 400, and the control unit 500. The support unit 110 may be provided with a buffer (not shown) for alleviating the impact when the delivery goods 20 that are mailed are put in the landing unit 100.

The opening/closing unit 120 is installed on the support unit 110 and may open and close the support unit 110. The opening/closing unit 120 may be installed on the supporting unit 110 while being spaced apart from the supporting unit 110 in order to protect the mailed delivery goods 20 to the supporting unit 110 from external environments such as dust and rainwater. The opening/closing unit 120 may be of an opening/closing type, and the opening/closing unit 120 opens when the drone 10 approaches to expose the support unit 110, and closes when the drone 10 leaves the support unit 110.

The landing control unit 130 may adjust a position at which the delivery goods 20 is landed on the support unit 110. At this time, the landing control unit 130 may guide precise landing by recognizing the landing position as an image based on deep learning, and use a beacon when the drone 10 approaches the support unit 110.

The landing unit 100 may detect that the delivery goods 20 have been mailed to the landing unit 100, and then notify the remote operation unit 600.

The transfer unit 300 connects the landing unit 100 and the loading unit 200, and may transport the delivery goods 20 to the loading unit 200.

The transfer unit 300 includes a first transfer unit 310 installed on the support unit 110, a second transfer unit 320 installed under the support unit 110, a plurality of sensors 330 for recognizing the delivery goods 20, and a monitoring control unit 340 for monitoring the delivery goods 20.

The first transfer unit 310 is installed on the support unit 110, and may horizontally transfer the delivery goods 20 on the support unit 110 to a predetermined region, that is, the central region 110a of the support unit 110. That is, the first transfer unit 310 recognizes the delivery goods 20 mounted at a predetermined position of the support unit 110, receives the delivery goods 20, and transfers the delivery goods 20 to the central region 110a of the support unit 110.

The second transfer unit 320 may transfer the delivery goods 20 collected in the central region 110a of the support unit 110 by the first transfer unit 310 to the loading unit 200. The second transfer unit 320 may include a stacker crane, but is not limited thereto, and various structures are possible as long as the structure is capable of transferring the delivery goods 20. The second transfer unit 320 may move to the central region 110a of the support unit 110 and wait for alignment, transfer the delivery goods 20 up, down, left, and right, and put the delivery goods 20 into the loading unit 200. In other words, the second transfer unit 320 receives the delivery goods 20 when the delivery goods 20 move to the central region 110a of the support unit 110 by the first transfer unit 310 and positions the delivery goods 20 in front of the corresponding container box 210 of the loading unit 200 according to customer information. At this time, the second transfer unit 320 receives the information for transferring the delivery goods 20 up, down, left, and right, that is, the customer information from the remote operation unit 600 through the control unit 500, and moves the delivery goods 20 to the position of the corresponding container box 210 based on the customer information. However, the present invention is not necessarily limited thereto, and the second transfer unit 320 may further include a navigation unit (not shown) that finds the position of the empty container box 210 by itself. In this case, it is also possible to directly find a position of an empty container box 210 through the navigation unit, load the delivery goods 20 into the empty container box 210, and transmit information on the loaded container box 210 to the remote operation unit 600.

The plurality of sensors 330 and the monitoring control unit 340 detect the size, number, weight, etc. of the delivery goods 20 so that the first transfer unit 310 and the second transfer unit 320 can smoothly transfer the delivery goods.

The loading unit 200 is located under the landing unit 100 and can put and store the delivery goods 20. The loading unit 200 may include a plurality of container boxes 210, and a goods loading means 220.

The plurality of container boxes 210 store the delivery goods 20, are storage spaces tailored to the size of the delivery goods 20, and may be formed of various sizes and numbers of container boxes according to uses.

The goods loading means 220 may put the delivery goods 20, which are located in front of the container box 210 by the second transfer unit 320, into the container box 210. The goods loading means 220 may include, but are not limited to, a transport belt or a roller, and various structures are possible.

The interface unit 400 may deliver the delivery goods 20 stored in the loading unit 200 to the customer. The interface unit 400 communicates with the remote operation unit 600 through the control unit 500 after the delivery goods 20 are stored in the container box 210 to notify the customer of the arrival of the goods. Such a customer notification means may include, but are not limited to, a smartphone app for customer notification, and various forms are possible.

When the delivery goods 20 are stored in the container box, the interface unit 400 may upgrade the goods storage information and display it in the container box 210 using a display means such as a display or LED. The customer may open and close the container box 210 using the interface unit 400. In this case, the interface unit 400 may further include a security processing unit that allows the customer to safely open the container box 210 and receive the delivery goods.

The control unit 500 may be connected to the landing unit 100, the loading unit 200, the transfer unit 300, and the interface unit 400 to control them. The remote operation unit 600 may provide information about the size and weight of the delivery goods 20 to the control unit 500.

The remote operation unit 600 may be connected to the drone 10 and the control unit 500 to control the control unit 500 through wired or wireless communication. The remote operation unit 600 detects the landing and takeoff of the drone 10 through communication with the drone through a communication protocol, for example, a communication protocol such as WiFi, LTE, and 5G, a communication protocol used in the drone 10, a sensor, image recognition, etc., and transmits the detection result to the control unit 500 to control the unmanned goods supply system.

The control unit 500 and the remote operation unit 600 may notify the customer through a predetermined communication means.

The remote operation unit 600 may be linked with a logistics service provider through wired or wireless communication to manage from reception to delivery of logistics services.

As described above, the unmanned goods supply system using a drone according to an embodiment of the present invention unmannedly transports, stores, loads, and delivers delivery goods delivered by the drone, so that customers, particularly customers in regions where goods delivery is vulnerable, can conveniently pick up the delivery goods at the desired time.

Therefore, it is possible to reduce the labor load of a postman and a courier, thereby improving the operational efficiency of the entire distribution and logistics service.

In addition, delivery time can be significantly shortened by delivering heavy goods of 10 kg or more to customers in vulnerable regions for delivering, such as islands or mountainous regions.

In addition, as it operates unattended, it can safely deliver goods non-face-to-face. Because the delivery goods are safely stored, it is possible to prevent theft, damage, etc. Secure documents or secure items can be safely delivered without revealing the identity of the customer. Furthermore, the customer can conveniently receive the delivery goods at the desired time.

Further, even when the delivery goods are not directly delivered and are returned, the delivery goods can be unmannedly transported, stored, and loaded, thereby reducing transport costs.

Although the present invention has been described through preferred embodiments as described above, the present invention is not limited thereto and various modifications and variations are possible without departing from the concept and scope of the following claims. Those in the technical field to which it belongs will readily understand.

<Description of symbols>

100: landing unit
110: Support unit
120: Opening/closing unit
200: Loading unit
300: Transfer unit
400: Interface unit
500: Control unit
600: Remote operation unit

What is claimed is:

1. An unmanned goods supply system using a drone, comprising:
a landing unit to which delivery goods are mailed by the drone;
a transfer unit for transferring the delivery goods mailed to the landing unit;
a loading unit that is located under the landing unit and stores the delivery goods transported by the transfer unit; and
an interface unit for delivering the delivery goods stored in the loading unit to a customer,
wherein the transfer unit comprises
a first transfer unit that is installed on the landing unit and horizontally transports the delivery goods to a predetermined region on the landing unit, and
a second transfer unit for transferring the delivery goods collected in the predetermined region to the loading unit.

2. The unmanned goods supply system of claim 1, wherein
the second transfer unit comprises a stacker crane that transfers the delivery goods up, down, left, and right, and puts the delivery goods into the loading unit.

3. The unmanned goods supply system of claim 2, wherein
the second transfer unit further comprises a navigation unit for finding an empty loading unit to which the delivery goods are put.

4. The unmanned goods supply system of claim 1, wherein
the transfer unit further comprises
a plurality of sensors for recognizing the delivery goods, and
a monitoring control unit for monitoring the delivery goods.

5. The unmanned goods supply system of claim 1, wherein
the landing unit comprises:
a support unit on which the delivery goods are mounted; and
an opening/closing unit that is installed on the support unit and opens and closes the support unit.

6. The unmanned goods supply system of claim 5, wherein
the landing unit further comprises a landing control unit for controlling a position at which the delivery goods are landed.

7. The unmanned goods supply system of claim 1, wherein
the loading unit comprises:
a plurality of container boxes for storing the delivery goods; and
a goods loading means for putting the delivery goods located in front of the container box by the second transfer unit into the container box.

8. The unmanned goods supply system of claim 1, further comprising:
a control unit for controlling the landing unit, the loading unit, the transfer unit, and the interface unit; and
a remote operation unit connected to the drone and the control unit to control the control unit through communication.

9. The unmanned goods supply system of claim 7, wherein
the remote operation unit is connected to the drone and the control unit in a predetermined communication method to detect that the drone takes off from the landing unit and delivers it to the control unit.

10. The unmanned goods supply system of claim 9, wherein
the control unit and the remote operation unit notify the customer through a predetermined communication means.
